(19) United States
(12) Patent Application Publication
(10) Pub. No.: US 2009/0053505 A1
(43) Pub. Date: Feb. 26, 2009

(54) METHOD OF ELIMINATING AND MONITORING THE ELIMINATION OF ALUMINUM OXIDE AND OTHER MATERIALS AT THE BASE OF PORES IN POROUS ANODIZED ALUMINUM

(75) Inventors: David Thomas Crouse, New York, NY (US); Thomas Lee James, New York, NY (US); Ataul Aziz Ikram, Multan (PK)

Correspondence Address: Research Foundation of the City University of New;c/o Darby & Darby P.C., P.O. Box 770, Church Street Station, New York, NY, 10008-0770, US

(73) Assignees: Research Foundation of the City University of New York, New York, NY (US); Phoebus Optoelectronics, LLC, Brooklyn, NY (US)

(21) Appl. No.: 12/198,109

(22) Filed: Aug. 25, 2008

Related U.S. Application Data
(60) Provisional application No. 60/965,760, filed on Aug. 23, 2007.

(51) Int. Cl. B32B 3/26; C25D 9/06; C25D 5/00

(52) U.S. Cl. 428/315.9; 205/112

(57) ABSTRACT

The present invention is directed to the development of a nanoporous alumina template comprising a multilayer metal film structure that allows for the in situ removal of an electrically insulating barrier layer, thus exposing an electrode at the pore bases. An exemplary multilayer thin film precursor is developed herein which contains an aluminum anodization layer, a diffusion barrier and an electrode. Aluminum anodization in an acidic electrolyte solution with a subsequent voltage pulse sequence produces a nanoporous alumina template with a barrier free conductive electrode surface. The nanoporous template of the present invention provides an efficient means for electrodeposition of nanomaterials.

### CROSS-REFERENCE TO PRIOR APPLICATION

This application claims priority to U.S. Provisional Application Ser. No. 60/965,760 filed on Aug. 23, 2007, which is incorporated herein by reference in its entirety.

### GOVERNMENT INTEREST STATEMENT

This invention was made with Government support under Contract No. FA9453-06-C-0052 awarded by the U.S. Air Force. The Government has certain rights in this invention.

### FIELD OF THE INVENTION

The present invention generally relates to anodically generated nanoporous alumina templates, methods of production thereof, and their use as scaffolds for electrodeposition of nanomaterials.

### BACKGROUND OF THE INVENTION

The utilization of anodically generated nanoporous aluminum oxide (alumina) for template assisted production of nanomaterials is an area of active research. The small-scale pore structure of alumina is ideally suited to serve as a scaffold to pattern monodisperse nanocylinders of desired materials with controlled dimensions (1, 2, 3). Specifically, when arranged as a template in association with an adjacent conducting electrode surface, the porous alumina can be used, for example, as a host scaffold for the creation of nanostructures of deposited materials through electrochemical based deposition using a direct current (DC) galvanostatic method (1, 4, 5). Given the extensive utility of nanomaterials for diverse applications such as drug delivery, bioencapsulation and optoelectronic device technologies, methods that facilitate nanoscale fabrication are of considerable interest.

Porous alumina is prepared electrochemically from aluminum metal (6). When aluminum is anodized in an acidic electrolyte under controlled conditions, it oxidizes to form an alumina film comprising an organized array of cylindrical pores that are oriented perpendicular to the film surface (7, 8). It is observed that pores emerge on one end of the alumina surface and propagate down towards, for example, an alumina/electrode interface with concomitant formation of an oxide barrier layer at the bottom of each pore (9). Pore densities as high as 10¹¹ pores per square centimeter of alumina have been achieved and the pores are typically arranged in a hexagonal array (10). Pore diameters characteristically range in size from 5 to 250 nm depending on the anodization conditions used, and empirical formulas can be employed for precise calculation of pore diameter and spacing at a specific applied voltage (6, 11, 12).

There are many challenges associated with the preparation and utilization of thin film alumina templates. For example, efforts to prepare Al—Pt and Al—Au bilayer templates for nanowire deposition have been hindered because such compositions form intermetallic species at room temperature and promote a deleterious Oxygen Evolution Reaction (OER) that initiates the formation of dissolved oxygen gas (13). In addition, inadequate metal adhesion and limited mechanical stability is observed when aluminum is anodized directly on platinum or gold metal surfaces (13).

In order to resolve the limitations associated with Al—Pt and Al—Au bilayers, multilayer film templates have been prepared that contain an adhesive diffusion layer between the aluminum and platinum or Au electrode films (14). However, multilayer alumina structures formed from the templates often lack uniformity and further contain an obtrusive oxide barrier layer at the base of the alumina pores. The barrier layer blocks the electrode surface at the base of the pores and can interfere with subsequent electrodeposition of nanomaterials.

Strategies to remove the metal oxide barrier layers generally require additional etching steps or involve fragile and tedious bulk alumina thermal evaporation techniques (14, 15). Such barrier removal methods are often labor intensive, damage the pores and disrupt the overall integrity of the template structure. Hence, there is a need for alumina template materials and methods for production thereof that allow for easy and uniform electrodeposition of nanomaterials with straightforward processing and minimal fabrication steps.

### SUMMARY OF THE INVENTION

The present invention provides a means for engineering nanoporous products with suitable characteristics, for example, the subsequent electrochemical deposition of nanomaterials. In one embodiment, the present invention provides a nanoporous product comprising:

an electrode layer;

an anodized diffusion layer disposed on the electrode layer; and

an anodized aluminum layer disposed on the anodized diffusion layer; wherein

the nanoporous product comprises a plurality of pores, and wherein at least 60% of the pores extend through the anodized aluminum layer and the diffusion barrier.

In another embodiment, the present invention provides a nanoporous product comprising:
an electrode layer;
an anodized diffusion layer disposed on the electrode layer; and
an anodized aluminum layer disposed on the anodized diffusion layer;
   wherein at least 60% of the pores extend through the multilayer template to expose an electrode surface area, and wherein at least 0.66% of the exposed surface area is exposed as a plurality of electrode surfaces having a surface area of from about 20 nm² to about 50,000 nm².

Another embodiment of the present invention includes a nanoporous product prepared by the process of:
(1) providing a multilayer template comprising an electrode layer, a diffusion layer disposed on the electrode layer, and an aluminum layer disposed on the diffusion layer;
(2) anodizing the multilayer template to produce an anodized multilayer template comprising a plurality of pores; and
(3) applying a pulse voltage sequence to the anodized multilayer template for a period of time sufficient to remove a barrier layer at the base of at least 60% of the pores; wherein
   at least 60% of the pores in the nanoporous product extend through the anodized multilayer template to expose a plurality of electrode surfaces.

Another embodiment of the present invention includes a process for preparing a nanoporous product, comprising the steps of:
(1) providing a multilayer template comprising an electrode layer, a diffusion layer disposed on the electrode layer, and an aluminum layer disposed on the diffusion layer;
(2) anodizing the multilayer template to produce an anodized multilayer template comprising a plurality of pores; and
(3) applying a pulse voltage sequence to the anodized multilayer template for a period of time sufficient to remove a barrier layer at the base of at least three of the plurality of pores.

Another embodiment of the present invention includes a method for monitoring pore formation in a nanoporous product, the method comprising the steps of:
(1) providing an anodized multilayer template comprising an electrode layer, an anodized diffusion layer disposed on the electrode layer, and an alumina layer comprising a plurality of pores disposed on the anodized diffusion layer, wherein a barrier layer is present at the base of more than 40% of the pores;
(2) applying a pulse voltage sequence to the anodized multilayer template;

(3) monitoring the corresponding current output during the pulse voltage sequence; and
(4) applying the pulse voltage sequence until a value of the rate of current magnitude increase is equal to or greater than the value obtained when 60% of the of the pores extend through the barrier layer to expose an electrode surface.
   Another embodiment of the present invention includes the use of a nanoporous product as a host template for electrodeposition of nanomaterials and applications thereof.

### BRIEF DESCRIPTION OF THE DRAWINGS

Non-limiting and non-exhaustive embodiments of the present invention are described with reference to the following drawings.

For a better understanding of the present invention, reference will be made to the following Detailed Description, which is to be read in association with the accompanying drawings, wherein:

FIG. 1 is an exemplary schematic cross-sectional view showing various stages of the formation of a nanoporous product. 1A shows a multilayer film template prior to anodization. 1B depicts pore propagation in a multilayer template during anodization. 1C shows a multilayer template after anodization with a barrier layer at the pore bases. 1D depicts a nanoporous product after application of a voltage pulse sequence that eliminated a barrier layer at the base of the pores.
Reference Numerals: (101) aluminum layer, (102) diffusion layer, (103) electrode layer (104) alumina, (105) propagating pore, (106) barrier layer, (107) unobstructed pore, (108) electrode surface

FIG. 2 is an exemplary plot of voltage applied to a multilayer thin film template during aluminum anodization with a subsequent voltage pulse sequence for barrier layer dissolution. A schematic illustration of the corresponding current recorded during anodization and barrier dissolution is also shown.
Reference Numerals: (201) voltage plot, (202) current plot, (203) anodization voltage, (204) voltage pulse sequence, (205) high current value, (206) low current value, (207) minimum current value, (208) end of anodization (209) current that signals barrier layer dissolution

FIG. 3 shows a voltage pulse sequence with a periodic set of voltage step functions for removing an oxide barrier layer at the base of the pores in a multilayer nanoporous alumina template. The corresponding electrical current profile is also illustrated.
Reference Numeral: (301) voltage step function

FIG. 4 shows a voltage pulse sequence with a periodic set of sinusoidal voltage profiles for removing an oxide barrier layer at the base of the pores in a multilayer nanoporous alumina template. The corresponding electrical current profile is also illustrated.
Reference Numeral: (401) sinusoidal voltage pulse

FIG. 5 shows a voltage pulse sequence with a periodic set of linear voltage profiles for removing an oxide barrier layer at the base of the pores in a multilayer nanoporous alumina template. The corresponding electrical current profile is also illustrated.
Reference Numeral: (501) linear voltage pulse

FIG. 6 shows a voltage pulse sequence with periodic linear voltage functions combined with voltage step functions for removing an oxide barrier layer at the base of the pores in a multilayer nanoporous alumina template. The corresponding electrical current profile is also illustrated.
Reference Numeral: (601) linear voltage pulse combined with voltage step function

FIG. 7 shows a voltage pulse sequence with periodic voltage step functions of increasing amplitude for removing an oxide barrier layer at the base of the pores in a multilayer nanoporous alumina template. The corresponding electrical current profile is also illustrated.
Reference Numeral: (701) voltage step functions of increasing amplitude

FIG. 8 shows a scanning electron microscopy (SEM) image of a multilayer thin film template immediately following anodization. The template comprises a silicon substrate, a titanium adhesion layer (7 nm), a platinum electrode (30 nm), a titanium diffusion layer (3 nm) and an alumina layer (500 nm). The alumina barrier layer found at the base of the alumina pores is shown in the image, and a titanium oxide barrier is also present (not shown).

FIG. 9 shows a SEM image of a multilayer thin film template after anodization and application of a series of 5 V pulses for a pulse duration of 35 ms and a total period of 2 s. The template comprises a silicon substrate, a titanium adhesion layer (7 nm), a platinum electrode (30 nm), a titanium diffusion layer (3 nm) and an alumina layer (500 nm). The barrier layer (FIG. 10) have been removed.

FIG. 10 shows the voltage applied to a multilayer thin film template during aluminum anodization with a subsequent voltage pulse sequence for barrier layer dissolution. The corresponding current recorded during anodization and barrier dissolution steps is also shown.

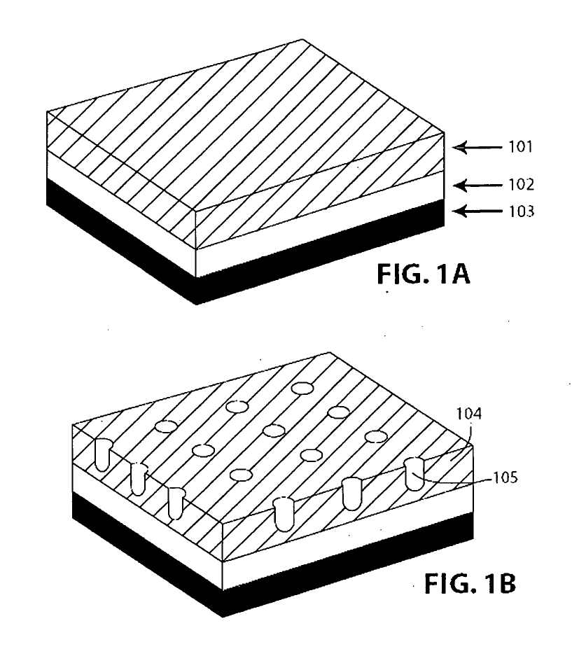

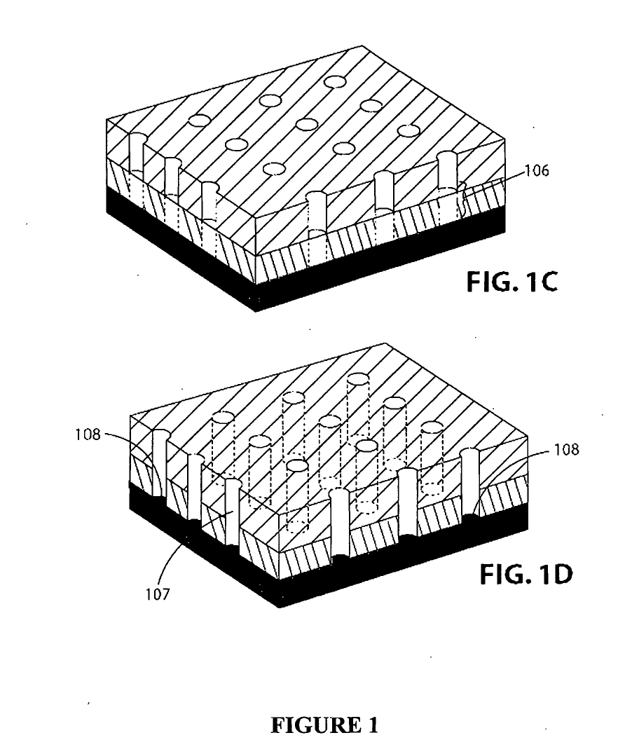

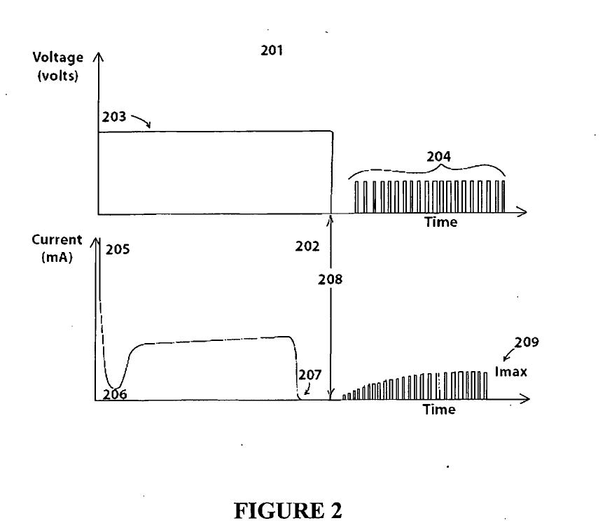

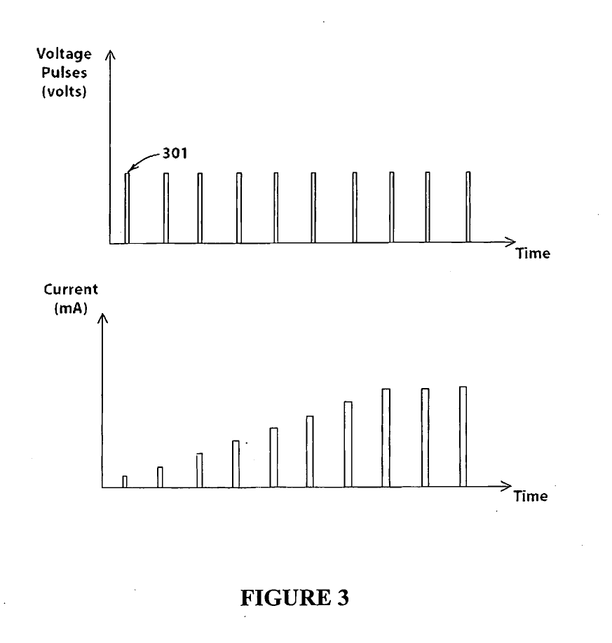

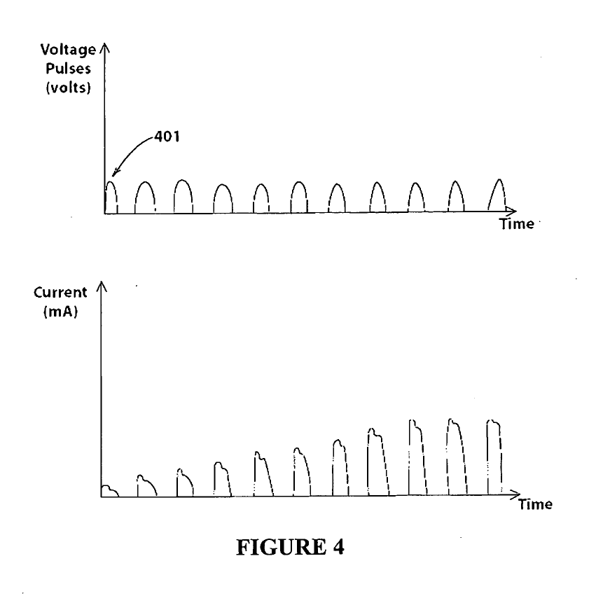

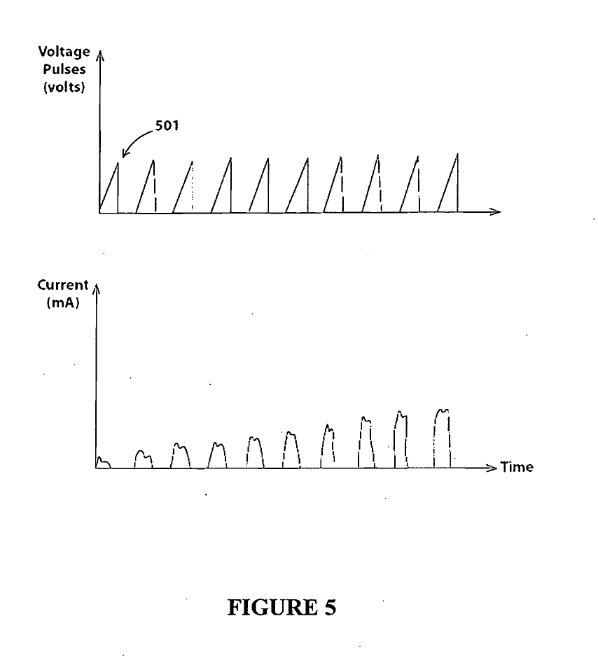

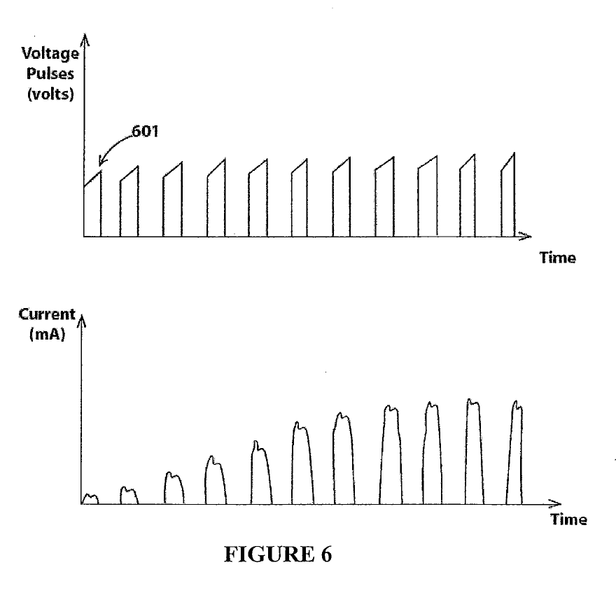

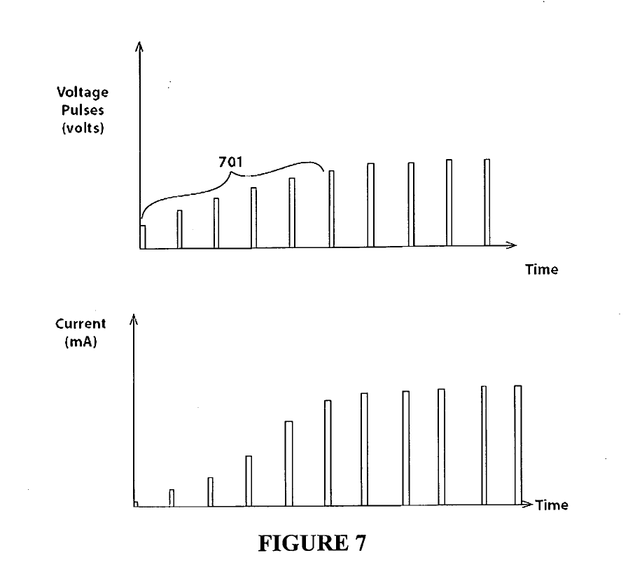

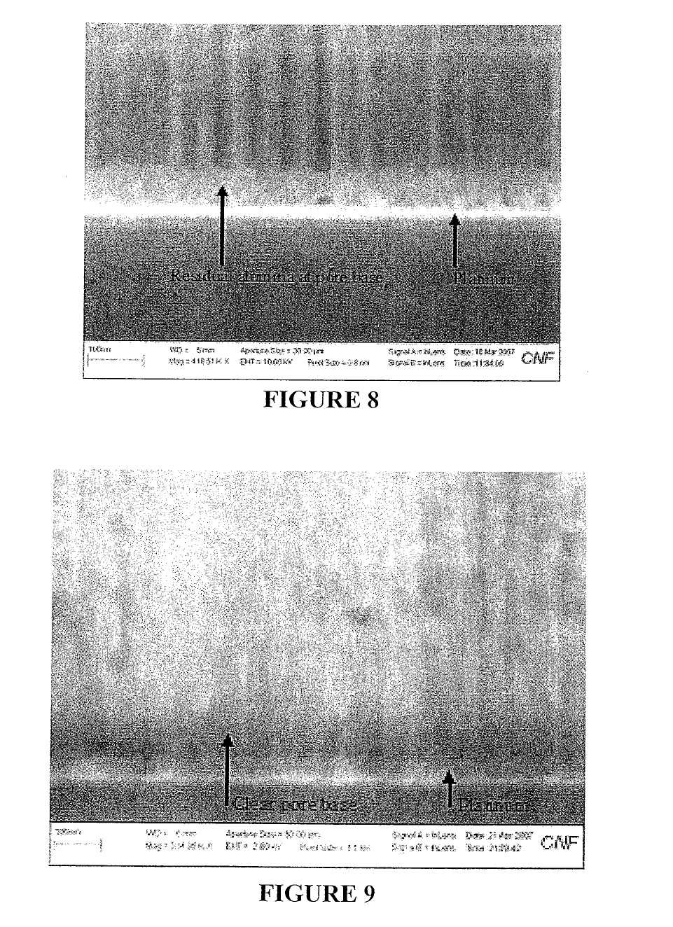

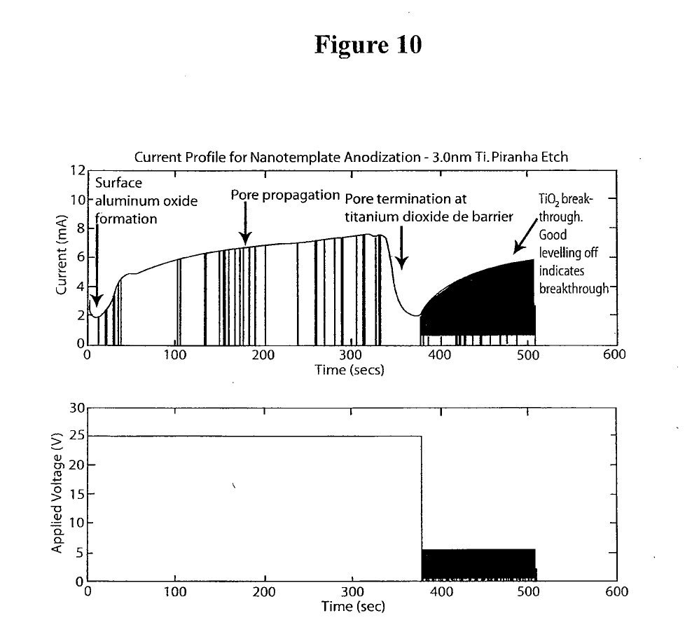

### DETAILED DESCRIPTION OF THE INVENTION

The present invention relates to nanoporous products for use in, for example, the electrodeposition of nanomaterials such as metals, semiconductors or metallic alloys. Specifically, a multilayer metal thin film nanoporous alumina template comprising a plurality of pores can be prepared using techniques that allow for in situ removal of an electrically insulating barrier layer, thus exposing an electrode at the base of at least some of the pores.

In one embodiment, the nanoporous product of the present invention comprises an electrode layer, an anodized diffusion layer disposed on the electrode layer, and an anodized aluminum layer disposed on the anodized diffusion layer. The electrode layer serves to, for example, drive the electrodeposition of various nanomaterials once the multilayer template structure has been fabricated. The electrode layer can be present at any thickness or dimension chosen by one skilled in the art. The electrode layer is present in the multilayer template at a thickness of from about 2 to about 10000 nm, preferably from about 2 to about 1000 nm, more preferably from about 10 to 100 nm. In one preferred embodiment of the present invention, the electrode layer is present at a thickness of 30 to 70 nm. The electrode layer can comprise any material that would facilitate the deposition of nanomaterials and is optionally composed of at least one of platinum, gold, silver, copper, palladium, osmium, rhodium, transparent conducting oxide or in-doped tin oxide, or combinations thereof. An electrode comprising platinum is preferred.

One embodiment of the present invention demonstrates the use of a diffusion layer disposed, for example, between the electrode layer and the aluminum layer in a multilayer template. The diffusion layer can, for example, prevent room temperature formation of intermetallic species that result from the mixing of the electrode and aluminum layers, and may provide good adhesion characteristics. The diffusion layer can comprise, for example a metal or a metal oxide thereof. The diffusion layer of the present invention is preferably selected from a group 4 or group 5 transition metal or oxides thereof, or a mixtures of group 4 or group 5 transition metals and/or oxides thereof. In one embodiment of the present invention, the diffusion layer is selected from at least one of titanium, tantalum, niobium chromium, zirconium, and oxides thereof. Titanium and tantalum and oxides thereof are most preferred. In one embodiment of the present invention, the diffusion layer optionally has the following characteristics: (1) the ability to deposit the diffusion layer of choice in the same physical vapor deposition device as other metals of the multilayer template, (2) fosters limited intermetallic formation with aluminum and/or electrode layers, (3) the anodization product of the diffusion layer material is preferably stable and selectively removable at the base of the pore by an in situ technique and (4) an anodization product of the diffusion (e.g., part of the barrier layer of the present invention) layer preferably suppresses the OER to allow field driven barrier layer removal at pore bases.

Titanium and titanium dioxide possess favorable metal adhesion characteristics. Titanium is quickly anodized upon completion of aluminum anodization and its oxide further suppresses OER. Titanium dioxide has a large bandgap which enables it to halt the pore propagation of alumina and prevents OER. Further, the lowest formation temperature for the Al—Ti intermetallic species is 350° C. and the lowest formation temperature of a Pt—Ti intermetallic species is 500° C., both of which are higher than any temperature encountered during the formation of the multilayer template.

According to the present invention, the diffusion layer is present in the multilayer template at, for example, a thickness of about 2 to about 100 nm. In one embodiment of the present invention, the diffusion layer is present at a thickness of about 2 to about 20 nm. In another embodiment of the invention, the diffusion layer is present at a thickness range of 2-7.5 nm. A thickness range of 2.5 to 4 nm is preferred.

The anodized aluminum layer can be prepared according to the present invention by, for example, anodizing aluminum to form a porous alumina material. The term “anodizing”, as used herein, refers to a process of subjecting a metal to electrolytic action at the anode of an electrochemical cell. When used in the context of the multilayer template, the term “anodizing” refers to the conversion of aluminum to alumina and optionally the conversion of the diffusion layer component(s) to the corresponding oxides. For example, in one embodiment of the present invention, a multilayer template comprises an electrode layer, a diffusion layer disposed on the electrode layer, and an aluminum layer disposed on the diffusion layer. In one embodiment of the present invention, the aluminum layer is present in the multilayer template at, for example a thickness of from about 50 to about 25,000 nm, preferably from about 250 to about 5000 nm, more preferably at a thickness range of 500 to 1500 nm. The multilayer template can be anodized to produce an anodized multilayer template comprising an electrode layer, an anodized diffusion layer disposed on the electrode layer and an alumina layer disposed on the anodized diffusion layer. In one embodiment of the present invention, an anodized multilayer template comprises an electrode layer such as platinum, an anodized diffusion layer comprising titanium oxide disposed on the electrode layer, and alumina disposed on the anodized diffusion layer. According to the present invention, the anodized aluminum layer can be present in the multilayer template at, for example, a thickness of from about 50 nm to about 30,000 nm.

In one embodiment of the present invention, the multilayer template comprises a barrier layer at the pore bases. As used herein, the term “barrier layer” refers to an obtrusive layer at the pore bases that blocks access to the electrode layer. In one embodiment of the present invention, the barrier layer interferes with subsequent electrodeposition of nanomaterials in the pores of the nanoporous product. According to the present invention, the barrier layer may comprise, for example, alumina at the base of the pores. The barrier layer may further comprise diffusion layer components at the base of the pores. In one embodiment of the present invention, the diffusion layer is anodized to form a part of the barrier layer. The barrier layer can comprise, for example, alumina and titanium dioxide. In another embodiment of the present invention, the barrier layer comprises alumina and tantalum oxide.

In another embodiment of the present invention, the nanoporous product further comprises a substrate disposed below the electrode layer. The substrate layer can be any material and preferably provides mechanical stability and preferably allows integration with integrated circuit components. Substrates used herein can be, but are not limited to silicon, gallium arsenide, indium phosphide, any semiconductor, glass, quartz, fused silica, sapphire, plastic or any polymer. The substrate layer can be present at any thickness or dimension chosen by one skilled in the art. In one embodiment of the present invention, the substrate is a silicon wafer with a thickness within the range of 100 to 5000 μm, preferably within the range of 100 to 1000 μm and more preferably within the range of 200 to 400 μm.

In another embodiment of the present invention, the nanoporous product further comprises an adhesion layer disposed between the electrode layer and the substrate. The adhesion layer at the interface of the substrate and electrode layers can be any material that functions to facilitate efficient binding of the electrode layer with the substrate layer. The adhesion layer can optionally comprise any group 4 or group 5 metal. Preferable materials include, but are not limited to, titanium, chromium, tantalum, niobium, and zirconium. Titanium and chromium are preferred.

According to the present invention, the adhesion layer is preferably present in the multilayer template at any thickness or dimension chosen by one skilled in the art. Fore example in the adhesion layer can be present at a thickness in the range from about 2 to about 100 nm, preferably from about 5 to 50 nm and more preferably from about 8 to 12 nm. In one preferred embodiment of the present invention the thickness of the adhesion layer is 10 nm.

In another embodiment, the nanoporous product of the present invention comprises a plurality of pores, wherein at least 60-100% of the pores extend through the anodized aluminum layer and the diffusion layer. Preferably 80-100% of the pores extend through the anodized aluminum layer and the diffusion layer. 95-100% is most preferable. The extended pores can propagate partially or entirely through the alumina and diffusion layers. Full extension of the pores down to the electrode layer is preferable. According to the present invention, the diameter of the pores optionally ranges from about 5 to about 250 nm. Particularly, the pore diameters can range from 2-50 nm. Furthermore, the depth of the pores is optionally 30 μm or less.

In another embodiment, the nanoporous product of the present invention contains a plurality of pores wherein at least 60% of the pores extend through the anodized aluminum layer and the diffusion layer to expose a plurality of electrode surfaces. In another embodiment, each of the plurality of electrode surfaces has a surface area of from about 20 nm² to about 50,000 nm². In another embodiment of the present invention, each plurality of electrode surfaces has a surface area of from about 315 nm² to about 1,965 mm². In an alternative embodiment, the nanoporous product of the present invention contains a plurality of pores wherein at least 60% of the pores extend through the anodized aluminum layer and the diffusion layer to expose a plurality of electrode surfaces, and wherein at least 66% of the exposed surface area is exposed as a plurality of electrode surfaces having a surface area of from about 20 nm² to about 50,000 nm². Preferably, at least 75% of the exposed surface area is exposed as a plurality of electrode surfaces having a surface area of from about 20 nm² to about 50,000 nm². More preferably, at least 85% of the exposed surface area is exposed as a plurality of electrode surfaces having a surface area of from about 20 nm² to about 50,000 nm². Most preferably, at least 95% of the exposed surface area is exposed as a plurality of electrode surfaces having a surface area of from about 20 nm² to about 50,000 nm².

In one embodiment of the present invention, the nanoporous product is prepared by the process of (1) providing a multilayer template comprising an electrode layer, a diffusion layer disposed on the electrode layer and an aluminum layer disposed on the diffusion layer; (2) anodizing the multilayer template to produce an anodized multilayer template comprising a plurality of pores; and (3) applying a pulse voltage sequence to the anodized multilayer template for a period of time sufficient to remove a barrier layer at the base of the pores; wherein at least 60% of the pores in the nanoporous product extend through the multilayer template to expose a plurality of electrode surfaces.

The present invention also provides for a process for preparing a nanoporous product comprising the steps of (1) providing a multilayer template comprising an electrode layer, a diffusion layer disposed on the electrode layer and an aluminum layer disposed on the diffusion layer; (2) anodizing the multilayer template to produce an anodized multilayer template comprising a plurality of pores; and (3) applying a pulse voltage sequence to the anodized multilayer template for a period of time sufficient to remove a barrier layer at the base of the pores; wherein at least 60% of the pores in the nanoporous product extend through the multilayer template to expose a plurality of electrode surfaces.

Methods for fabricating a mulitlayer thin film template can be found in U.S. Pat. No. 6,869,671, the entire contents and disclosure of which is hereby incorporated by reference.

Fabrication of the nanoporous product of the present invention can involve, for example, anodization and barrier layer removal at the pore bases so that the nanoporous product may be used as a scaffold for electrodeposition of various materials such as metals, semiconductors or metallic alloys. In order to prepare a nanoporous product of the present invention, an aluminum template made from a multilayer metal film structure can be prepared or provided as a precursor.

The aluminum multilayer template can be prepared, for example by e-beam evaporation of metal film layers onto a substrate. An aluminum template may comprise a substrate layer, an electrode layer disposed on the substrate layer, a diffusion layer disposed on the electrode layer, and an aluminum layer disposed on the diffusion layer. The substrate used for template construction may include n-type, p-type or undoped silicon substrates cut into, for example, 15 mm diameter discs or 1.5 cm² squares.

In one embodiment of the present invention, the aluminum template is anodized using an acidic electrolyte solution or other anodization conditions familiar to those skilled in the art. A wide range of acid electrolytes can be used in the present invention, such as sulfuric acid, oxalic acid, phosphoric acid, citric acid, etc. The anodization voltage can be selected by one of ordinary skill in the art to create the desired alumina pore diameter. For example, an anodization voltage range of 0-100 V DC may be used. Anodization ranges of 10-50 V are preferable. In one embodiment of the present invention, an anodization voltage range of 25-27 V is used.

The anodization reaction and the subsequent voltage pulse sequence of the present invention can also be controlled and monitored on a digital acquisition system that regulates applied voltage and current and can, optionally, also detect voltage and current signal outputs.

In one embodiment of the present invention, the pulse voltage sequences used herein can comprise periodic voltage profiles selected from voltage step functions, sinusoidal voltage profiles, linear voltage functions, linear voltage functions combined with voltage step functions, and voltage step functions of increasing voltage, or combinations thereof. The pulse voltage sequence of the present invention comprises, for example, at least 2 pulses. Generally, the time duration of the pulse sequence, the number of pulses and the time period between each pulse will vary according to the thickness of the diffusion layer (and subsequently formed barrier layer) of the present invention.

In another embodiment, voltages within the range of −50 to +50 V are applied during the pulse voltage sequence of the present invention. For example, voltages within the range of −25 to 25 V, −25 to 0 V, −15 to −5 V, 0 to 25 V and +5 to +25 can be used. Pulse sequence voltage ranges of −20 to 20 V are preferred. Pulse sequence voltage ranges of −15 to 10 V are particularly preferred.

In one embodiment of the present invention, the time duration of each pulse in the voltage pulse sequence of the present invention is within the range of 1 μs to 5 s. In another embodiment of the present invention, the time duration of each pulse is within the range of 0.01 s to 1 s. In another embodiment, the time duration of each pulse is within the range of 0.05 to 0.25 s.

In another embodiment of the present invention, the time period between each pulse in the voltage pulse sequence is with in the range of 1 μs to 10 minutes. In another embodiment of the present invention, the time period between each pulse is from about 0.01 s to about 5 s. In another embodiment of the present invention, the time period between each pulse is from about 0.75 s to about 0.95 s.

In another embodiment of the present invention, the voltage pulse sequence occurs at a temperature within the range of 5 to 50° C. In one embodiment of the present invention, the voltage pulse sequence occurs at a temperature range of 20 to 40° C. In another embodiment, the voltage pulse sequence occurs at a temperature range of 27.5 to 32.5° C. In one embodiment, the temperature remains constant during the voltage pulse sequence of the present invention. In another embodiment, the temperature is varied.

Another embodiment of the present invention calls for a process for preparing a nanoporous product wherein a voltage ramping sequence is applied to the nanoporous alumina template subsequent to the anodizing step and prior to the voltage pulse step. The voltage ramping sequence can have, but is not limited to, a voltage within the range of 0 to 50 V, preferably within the range of 10 to 40 V. In one preferred embodiment of the present invention, the voltage ramping sequence is carried out at 25 to 35 V.

Another embodiment of the present invention provides for a method of monitoring pore formation in the nanoporous product described herein. In one embodiment, the method of monitoring pore formation comprises the steps of (1) providing an anodized multilayer template comprising an electrode layer, an anodized diffusion layer disposed on the electrode layer, and an alumina layer comprising a plurality of pores disposed on the diffusion layer, wherein a barrier layer is present at the base of more than 40% of the pores; (2) applying a pulse voltage sequence to the anodized multilayer template; (3) monitoring the corresponding current output during the pulse voltage sequence; and (4) applying the pulse voltage sequence until a value of the rate of current magnitude increase is equal to or greater than the value obtained when 60% of the pores extend through the barrier layer to expose an electrode surface.

In one embodiment of the present invention, the method of monitoring pore formation comprises monitoring the voltage sequence until the change in current magnitude over time is within the range of 0.1 mA/s to 1 mA/s for each 1 cm² of anodized area of alumina and for a rate of increase of the voltage amplitude magnitude of the voltage pulses of at least 0.0025 V/s. One characteristic that may indicate pore extension to the electrode layer by barrier layer removal is, for example, a smoothly increasing current (with an exponentially increasing current magnitude dependence on voltage magnitude) as the voltage is pulsed to progressively higher magnitude values. Additionally, a uniform production of hydrogen (for negative voltage pulses) and/or oxygen (for positive voltage pulses) may indicate a pore extension to the electrode layer by barrier layer removal.

In another embodiment of the present invention, the method for monitoring pore formation further comprises cyclic voltammetry analysis between at least two pulses in the pulse voltage sequence. Cyclic voltammetry is a process in which applied voltage is swept in a linear or stepwise fashion at a precise rate from a starting voltage value to some more positive value, then back to the starting voltage value, then to some more negative value and then back to the starting voltage value, i.e., a voltage sweep that is cyclical in nature. The direction of the applied voltage sweep can also begin in a negative direction, thereby traversing the opposing direction as that described immediately above. By analyzing the resulting current as a function of voltage as well as the rate of change of current versus rate of change of voltage, one can determine if the interface between the pore and the substrate is electrically conductive or electrically insulating. For example, a conductive interface is characterized by a smoothly increasing (exponential in shape) current magnitude with a linear increase in voltage magnitude.

It has been found herein that the use of a voltage pulse sequence following template anodization allows for eliminating the barrier layer at the pore bases. Specifically, this novel method produces nanoporous products that are structurally intact and contain uniform, barrier free pores that extend down to the electrode layer of the template. The method of the present invention allows for easy and complete in situ barrier removal, while maintaining the overall structural integrity of the nanoporous product.

The nanoporous product of the present invention provides a nanostructured template for subsequent electrochemical deposition of nanomaterials. The present invention may be applied to various related areas which may be evident to one of ordinary skill in the art. Such applications include, but are not limited to, the construction of biofuel cells, nanowire synthesis and orientation, quantum dot synthesis, magnetic memory arrays, solar cells, carbon nanotube synthesis and orientation, chemical and biological sensors and photodetectors.

In one embodiment of the present invention, the nanoporous product is used as a synthetic host for electrochemically deposited materials such as gold, silver, transition metals, II-VI semiconductors, or conductive polymers. The present invention provides for the elimination of the barrier layer and provides a barrier free conductive surface at the pore base. Hence direct current (DC) can be used to fabricate, for example, nanosized metal posts or quantum dots. The templated nanoscale materials deposited on the conductive surface can further be coupled with integrated circuit (IC) circuitry.

In another embodiment of the present invention, heterostructures, superlattices or embedded quantum dots comprising combinations of II-VI semiconductors such as cadmium sulfide, cadmium selenide and cadmium telluride may be deposited into the pores of the nanoporous product for the construction of high-performance, high-temperature infrared photodetectors known as “Quantum Wire Infrared Photodetectors”.

In another embodiment of the present invention, first row transition metals such as nickel can be deposited into the pores of the nanoporous product for the construction of ultra-high-density magnetic memory arrays.

In another embodiment, quantum dots may be prepared using the nanoporous product of the present invention by rapid “flash” deposition of first row transition metals such as cobalt at the base of the nanoscale pores. The quantum dot present at each pore base can further be used, for example, as a catalytic surface for the subsequent growth of vertically oriented carbon nanotubes.

In another embodiment of the present invention, metals may be deposited into the pores of the nanoporous product by, for example, AC electrochemical seeding of the pore bottom followed by electrolysis growth of metal wires using a commercial electroless plating solution. For example, gold may be deposited into the pores of the template by AC electrochemical seeding of the pore bottom with 1 g/L HAuCl₄.3H₂O with 7 g/L H₂SO₄ with subsequent electroless growth of gold wires using an electroless plating solution such as Neorum TWB solution (Uyemura International Corporation).

Depending on the intended application, the alumina matrix may either remain in place or be removed after electrodeposition of nanomaterials into the pores of the template to produced various nanopatterned surfaces.

One embodiment of the present invention provides for a biosensor for the rapid detection of biomolecules. Such a biosensor may be used to detect antibodies, bacteria and proteins in a variety of environments, for example, in clinical diagnostics, food analysis and environmental monitoring. Nanostructured materials which are fabricated using the nanoporous product of the present invention may further be used as substrates to immobilize a biorecognition layer. Electrochemical detections may be applied for direct, label-free, and fast measurements of the analytes.

FIG. 1 is an exemplary schematic cross sectional view showing various stages of the formation of the nanoporous product of the present invention. FIG. 1A shows a multilayer film template prior to anodization. Layer 103 of the multilayer template serves as the electrode on which, for example, the electrodeposition of a wide range of materials will be performed after the nanoporous product is fabricated. The thickness of the electrode layer is typically in the range of 5 to 10000 nm. Layer 102 serves as a diffusion layer and is typically titanium or tantalum present at a thickness of 2-10 nm. The barrier layer creates a barrier between the aluminum and the electrode and therefore eliminates the formation of intermetallics between the electrode and the aluminum layer during the subsequent anodization step. The aluminum layer 101 is disposed on the diffusion layer and is typically present at a thickness range of 500 to 1500 nm. FIG. 1B depicts pore propagation 105 in a multilayer template during anodization. During anodization, the aluminum layer is oxidized to porous alumina 104. The diffusion layer also becomes oxidized during anodization. For example, during anodization, a diffusion layer comprising titanium or tantalum can be converted to titanium oxide or tantalum oxide respectively. The oxidation of the diffusion layer subsequently stops further anodization. FIG. 1C depicts the multilayer template after anodization and before application of a voltage pulse sequence of the present invention. A barrier layer 106 is present at the base of the pores. FIG. 1D depicts a nanoporous product after application of a voltage pulse sequence of the present invention. The pores 107 are barrier free and terminate at the electrode surface 108.

FIG. 2 illustrates an exemplary voltage sequence of the present invention. The voltage 203 and/or current 205 is applied to the system in order to anodize the aluminum and diffusion layers and subsequently remove the barrier layer at the base of the pores. The anodization step can be performed, for example by using a constant voltage, or the anodization can be initiated using a constant current, or the anodization can be performed using alternating intervals of constant voltage and constant current. As depicted in FIG. 2, aluminum anodization can be initiated at a constant voltage 203 while the output current varies. The process can begin with a high current 205 followed by a current decrease to a minimum at 206 indicating oxidation of the aluminum surface to alumina, followed by an increase in current as pore propagation begins. Eventually, a steady state pore propagation condition is reached. Once the porous alumina formation is completed, and the diffusion layer is oxidized, the current decreases rapidly to a minimum 207. This marks the end of the anodization 208, wherein the multilayer structure is depicted as in FIG. 1C, with the barrier layer 106 at the base of the pores. Next, the voltage pulsing procedure 204 of the present invention is performed. The current during the pulse sequence can be monitored to record the point at which the oxide barrier layer is eliminated. Specifically, removal of the barrier layer is exemplified experimentally when, during the pulse sequence of the present invention, the current approaches a certain predetermined value, 209, in an asymptotic, linear, exponential, etc. fashion. Alternatively, the barrier layer is sufficiently removed when the rate of increasing current magnitude during the pulse sequence increases to a rate of 0.1 mA/s to 1 mA/s for each 1 cm² of anodized area for a rate of voltage magnitude increase of the voltage pulses of at least 0.0025V/s.

FIG. 3 illustrates a pulse sequence wherein the voltage pulses are constant amplitude step functions 301 exhibiting a voltage range of −50 to 50 V, with a short time duration (1 microseconds to 5 seconds) and a period between the pulse in the range of 2 microseconds to 10 minutes.

FIG. 4 illustrates another embodiment of the present invention, wherein the voltage pulses can be sinusoidal in shape 401 with an amplitude ranging from −50 to 50 V, a duration of 1 microseconds to 5 seconds and a period between the pulse in the range of 1 microseconds to 10 minutes.

In another embodiment of the present invention, as shown in FIG. 5, the voltage pulses can be linear in shape 501 with an amplitude of −50 to 50 V, a duration of 1 microseconds to 5 seconds and a period between the pulse in the range of 1 microseconds to 10 minutes.

In another embodiment, as shown in FIG. 6, the voltage pulses can be a combination of a step function and linear 601 sinusoidal or any other profile, with an amplitude of −50 to 50 V, a duration of 1 microseconds to 5 seconds and a period between the pulse in the range of 1 microseconds to 10 minutes.

In another embodiment, shown in FIG. 7, the voltage pulses can be step functions, linear, sinusoidal, or any other profile with an amplitude that either increases 701 or decreases for each subsequent pulse with the pulse amplitudes remaining in the range of −50 to 50 V, a duration of 1 microseconds to 5 seconds and a period between the pulse in the range of 1 microseconds to 10 minutes.

In another embodiment of the present invention, the voltage pulses can be any arbitrary function of time with pulse amplitudes within the range of −50 to 50 V, at a duration of 1 microseconds to 5 seconds and a period between each pulse in the range of 1 microseconds to 10 minutes.

Without further elaboration, it is believed that one skilled in the art can, using the preceding description, utilize the present invention to its fullest extent. The following examples are, therefore, to be construed as merely illustrative, and not limitative of the remainder of the disclosure in any way whatsoever.

### EXAMPLE 1

### Multilayer Template Fabrication and Anodization

The multilayer template samples were made using n-type or p-type silicon substrates prepared as either 4-inch discs or as 15 mm square wafers. Each substrate disc was cleaned by immersion in H₂O₂/NH₃OH and H₂O₂/HCl solutions. The cleaned substrates were then immediately placed in a vapor deposition device equipped with an e-beam evaporator under vacuum system for application of metal films.

Anodization of the formed aluminum metal template was executed in a jacketed glass reaction vessel that allows for agitation of the electrolyte at a controlled temperature. The aluminum films are typically anodized at approximately 26.5 V DC in a 0.5 M H₂SO₄ solution at 9-10° C. The subsequent pulsing procedure is carried out in a 0.5 M H₂SO₄ solution at approximately 30° C.

### EXAMPLE 2

### Template Characterization to Confirm Anodization and Removal of Barrier Layer

The anodization reaction and subsequent oxide barrier removal can be controlled and monitored on a digital acquisition system running LabVIEW© which operates the applied voltage and monitors the resulting current. During the anodization process, resolution of the current measurement is +/−0.05 mAmps (95% CI) and the voltage measurement resolution is +/−25 mV DC (95% CI) at a data collection frequency of at least 20 data points per second.

### REFERENCES

1. Crouse; Michael M., Miller; Albert E., Jiang; Juan, Crouse; David T., Basu; Subash C.; Enabling nanostructured materials via multilayer thin film precursor and applications to biosensors, U.S. Pat. No. 6,869,671, Mar. 22, 2005.
2. D. Routkevitch et al., J. Phys. Chem., 100, 14037 (1996).
3. P. Forrer et al., J. Appl. Electrochem. 30, 533 (2000).
4. D. Xu et al., Chem. Phys. Lett. 325, 340 (2000).
5. M. Crouse et al., Appl. Phys. Lett. 76, 49 (2000).
6. J. Sullivan et al., Proc. R. Soc. London, Ser. A. 317, 511 (1970).
7. C. Martin et al., Science. 266, 1961 (1994).
8. F. Keller et al., J. Electrochem. Soc. 100, 411 (1953).
9. M. Crouse et al., J. Electrochem. Soc. 152, D167 (2005).
10. D. AlMawiawi et al., J. Appl. Phys. 70, 4421 (1991).
11. C. Foss et al., J. Phys. Chem. 96, 7497 (1992).
12. C. Foss et al., J. Phys. Chem. 98, 2963 (1994).
13. Y. Yang et al., Solis State Commun. 123, 279 (2002).
14. O. Rabin et al., Adv. Funct. Mater. 13, 63 (2003).
15. N. Yasui et al., Appl. Phys. Lett. 83, 3347 (2003).

What is claimed is:

1. A nanoporous product comprising:
an electrode layer;
an anodized diffusion layer disposed on the electrode layer; and
an anodized aluminum layer disposed on the anodized diffusion layer
wherein the nanoporous product comprises a plurality of pores, wherein at least 60% of the pores extend through the anodized aluminum layer and the anodized diffusion layer.

2. The nanoporous product according to claim 1, wherein at least 60% of the pores extend through the anodized aluminum layer and the anodized diffusion layer to expose a plurality of electrode surfaces.

3. The nanoporous product according to claim 2, wherein each of the plurality of electrode surfaces has a surface area of from about 20 nm² to about 50,000 nm².

4. The nanoporous product according to claim 2, wherein each of the plurality of electrode surfaces has a surface area of from about 315 nm² to about 1,965 nm².

5. The nanoporous product according to claim 1, wherein at least 80% of the pores extend through the alumina layer and the diffusion layer.

6. The nanoporous product according to claim 1, wherein at least 95% of the pores extend through the alumina layer and the diffusion layer.

7. The nanoporous product according to claim 1, further comprising a substrate disposed below the electrode layer.

8. The nanoporous product, according to claim 7, further comprising an adhesion layer disposed between the electrode layer and the substrate.

9. The nanoporous product according to claim 1, wherein the diffusion layer comprises at least one of titanium, tantalum, niobium, zirconium, or chromium, or an oxide thereof.

10. The nanoporous product according to claim 9, wherein the diffusion layer comprises titanium, or an oxide thereof.

11. The nanoporous product according to claim 9, wherein the diffusion layer comprises tantalum or an oxide thereof.

12. The nanoporous product according to claim 1, wherein the electrode layer comprises at least one of platinum, gold, silver, copper, palladium, osmium, or rhodium, transparent conducting oxide or in-doped tin oxide or oxides thereof.

13. The nanoporous product according to claim 12, wherein the electrode layer comprises platinum or an oxide thereof.

14. The nanoporous product according to claim 12, wherein the electrode layer comprises gold or an oxide thereof.

15. The nanoporous product according to claim 1, wherein the diameter of the pores is from about 5 to about 250 nm.

16. The nanoporous product according to claim 1, wherein the diameter of the pores is from about 20 to about 100 nm.

17. The nanoporous product according to claims 1, wherein the depth of the pores is about 30 μm or less.

18. A nanoporous product comprising:
an electrode layer;
an anodized diffusion layer disposed on the electrode layer; and
an anodized aluminum layer disposed on the anodized diffusion layer
wherein at least 60% of the pores extend through the multilayer template to expose an electrode surface area, and wherein at least 0.66% of the exposed surface area is exposed as a plurality of electrode surfaces each having a surface area of from about 20 nm² to about 50,000 nm².

19. A nanoporous product prepared by the process of:
(1) providing a multilayer template comprising an electrode layer, a diffusion layer disposed on the electrode layer, and an aluminum layer disposed on the diffusion layer;
(2) anodizing the multilayer template to produce an anodized multilayer template comprising a plurality of pores; and
(3) applying a pulse voltage sequence to the anodized multilayer template for a period of time sufficient to remove a barrier layer at the base of at least 60% of the pores;
wherein at least 60% of the pores in the nanoporous product extend through the anodized multilayer template to expose a plurality of electrode surfaces.

20. A process for preparing a nanoporous product, comprising the steps of:
(1) providing a multilayer template comprising an electrode layer, a diffusion layer disposed on the electrode layer, and an aluminum layer disposed on the diffusion layer;
(2) anodizing the multilayer template to produce an anodized multilayer template comprising a plurality of pores; and
(3) applying a pulse voltage sequence to the anodized multilayer template for a period of time sufficient to remove a barrier layer at the base of at least three of the plurality of pores.

21. The process according to claims 19 or 20, wherein the voltage pulse sequence comprises periodic voltage profiles selected from the group consisting of voltage step functions, sinusoidal voltage profiles, linear voltage functions, linear voltage functions combined with voltage step functions, and voltage step functions of increasing voltage, or combinations thereof.

22. The process according to claims 19 or 20, wherein the aluminum layer and the diffusion layer are anodized in an acidic electrolyte.

23. The process according to claims 19 or 20 wherein a voltage from −50 to +50 V is applied during the voltage pulse sequence.

24. The process according to claims 19 or 20 wherein a voltage from −20 to +20 V is applied during the voltage pulse sequence.

25. The process according to claims 19 or 20 wherein a voltage from −15 to +10 V is applied during the voltage pulse sequence.

26. The process according to claims 19 or 20 wherein the time duration of each pulse in the voltage pulse sequence has a time duration of from 1 μs to 5 s.

27. The process according to claims 19 or 20 wherein the time period between each pulse in the voltage pulse sequence has a time duration of from 1 μs to 10 minutes.

28. The process according to claims 19 or 20 wherein the voltage pulse sequence occurs at a temperature from 5 to 50° C.

29. The process according to claims 19 or 20, wherein the voltage pulse sequence comprises at least two pulses.

30. The process according to claims 19 or 20 wherein a voltage ramping sequence is applied to the nanoporous product subsequent to the anodizing step and prior to the voltage pulse sequence.

31. The process according to claim 30 wherein the voltage ramping sequence has a voltage from 0 to 50V.

32. A method of monitoring pore formation in a nanoporous product, comprising the steps of:
(1) providing an anodized multilayer template comprising an electrode layer, an anodized diffusion layer disposed on the electrode layer, and an alumina layer comprising a plurality of pores disposed on the anodized diffusion layer, wherein a barrier layer is present at the base more than 40% of the pores;
(2) applying a pulse voltage sequence to the anodized multilayer template
(3) monitoring the corresponding current output during the pulse voltage sequence; and
(4) applying the pulse voltage sequence until a value of the rate of current magnitude increase is equal to or greater than the value obtained when 60% of the of the pores extend through the barrier layer to expose an electrode surface.

33. The method of monitoring pore formation according to claim 32, wherein the voltage is applied until the rate of current magnitude increase from of 0.1 mA/s to 1 mA/s for each 1 cm² of anodized area of alumina for a rate of voltage magnitude increase of the voltage pulses of at least 0.0025V/s.

34. The method of monitoring pore formation according to claim 32, further comprising cyclic voltammetry analysis between at least two pulses in the pulse voltage sequence.
